(19) United States
(12) Patent Application Publication
(10) Pub. No.: US 2007/0194186 A1
(43) Pub. Date: Aug. 23, 2007

(54) Multi-purpose non-slip rubber pads

(76) Inventor: James Roger Mars, Ft. Myers, FL (US)

Correspondence Address: MARS DISTRIBUTING INC., 19035 WEST BLUEMOUND ROAD, BROOKFIELD, WI, 53045, US

(21) Appl. No.: 11/356,994

(22) Filed: Feb. 21, 2006

(51) Int. Cl. F16B 47/00

(52) U.S. Cl. 248/206.2

(57) ABSTRACT

The apparatus pertains to stopping the horizontal movement of beds, chairs, tables, and furniture, boxes, pots, bowls, trays or anything that is placed on top of the pads that has at least weighs at least a half a pound.

### BACKGROUND OF THE INVENTION

1. Field of the Invention:

The present invention has to do with preventing the horizontal movement of all types and sizes of chairs, tables, sofas, beds, and furniture, boxes, pots, pans, bowls, trays or any item that is placed on top of the pads that weighs at least a half a pound.

There was also a need for a product that is thin enough to be placed under an item other than furniture, to prevent it from sliding and yet thick enough to do the job without ripping but not so thick that it would cause tipping.

When this apparatus is used to stop furniture from sliding across any kind of floor, there is no need to be concerned about the type or size of the legs. The Nexprene rubber will not only stop the legs from marking up the floor but can be used as an eraser to remove marks that already exist on the floor.

In previous inventions, the furniture had to be turned on its side, or lifted high enough vertically to have room to use a drill and screw driver or wrench to install their inventions. With this invention the furniture has to be lifted as little as a half an inch to allow the non-slip pad to be put in place.

An apparatus was needed for home use, work environments, nautical applications and musical applications to stop the horizontal movement of various items found in these environments.

2. Description of the Prior Art:

The prior art of preventing sliding of furniture is rubber cups that fit on the legs of chairs and tables or have bolts or screws that penetrate the leg bottoms. Since access to the leg bottoms to install their inventions is not easy in the case of large furniture, putting a non-slip pad, under the legs is as simple as lifting each corner of the furniture, one at a time and putting a non-slip pad under the leg. Unlike the inventions that slip over the bottom of the leg any size non-slip pad will work. If the user wants to completely hide the pads, the pads can be cut with heavy duty scissors or purchase a size that matches the diameter of the bottom of the legs.

### SUMMARY OF THE INVENTION

The apparatus consisting of an oval pad that has high adhering properties because of the suction cup holes and the low Durometer soft rubber that is applied to both sides of a polycarbonate flat bracket that will stop or greatly reduce movement in the horizontal direction of anything in the solid state that weighs six ounces or more, that is placed on top of it. The multi-purpose non slip pads prevent the sliding of beds, chairs, tables and other furniture without concern about the size or type of legs. In the case of sofas, not only will the sliding be restricted but the mark that is normally found across the wall that makes contact with a couch that has slid, will be eliminated. In When beds are property placed away from the wall and the pads are put in place, the head board will not bang the wall. Living room chairs will stay in place after the pads have been installed under the chair feet.

The pads can also be used when transporting food containers or boxes in any kind of vehicle. The nautical applications during rough water conditions are also numerous since the pads are saltwater proof, ultra-violet ray and heat resistant. They can be used to hold almost anything that would normally slide during rough seas as long as the surfaces are dry.

In the musical field there is a need for holding for example a Chellos in place. When the point is placed in one of the suction holes, the point hits the polycarbonate center so it can not damage the floor. Since the point is in the pad's hole and the pad does not slide there is no movement of the Chellos.

### BRIEF DESCRIPTION OF THE PICTURES

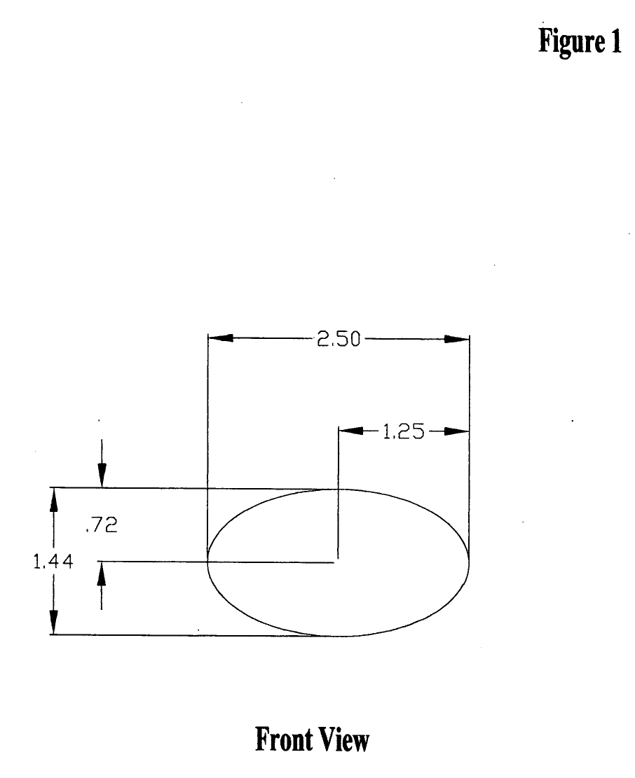

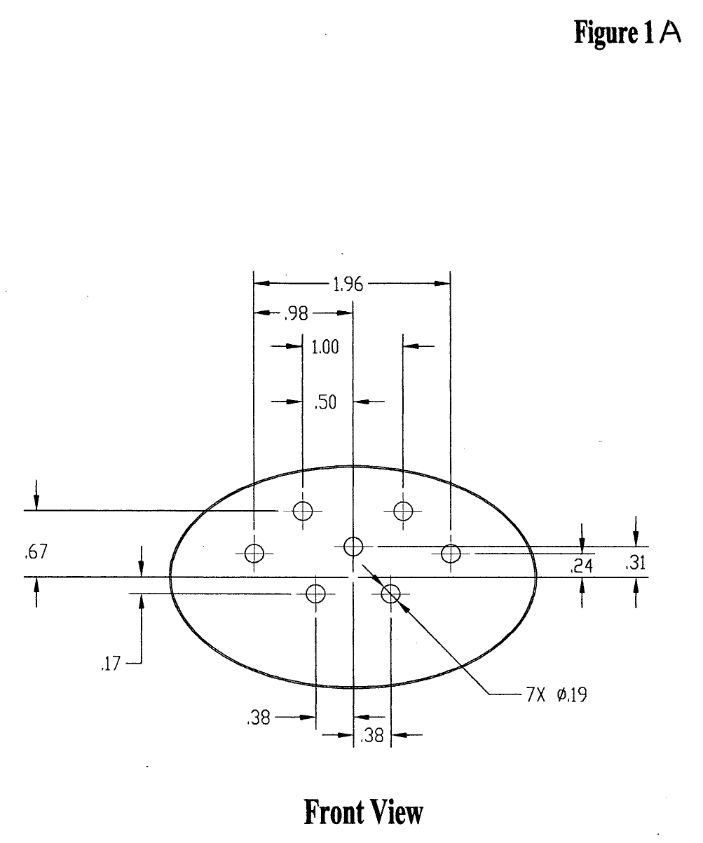

FIG. 1. Front view of oval polycarbonate blank before it is covered with rubber.

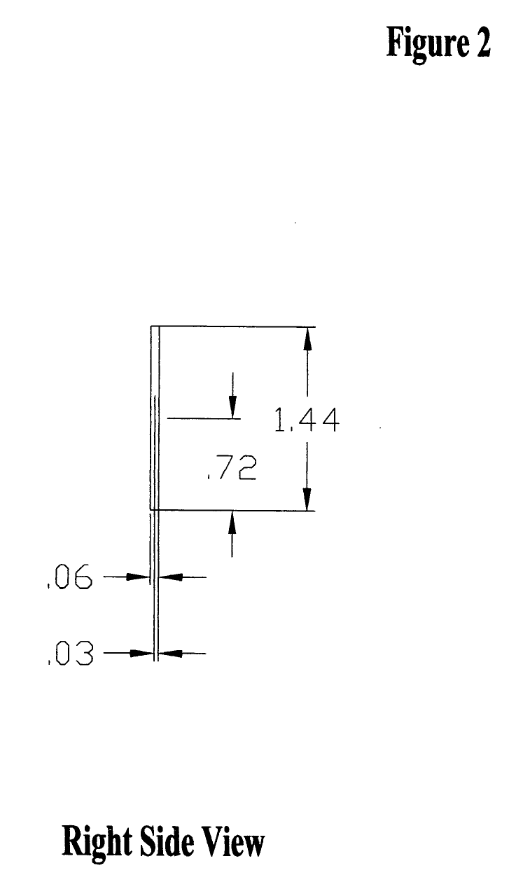

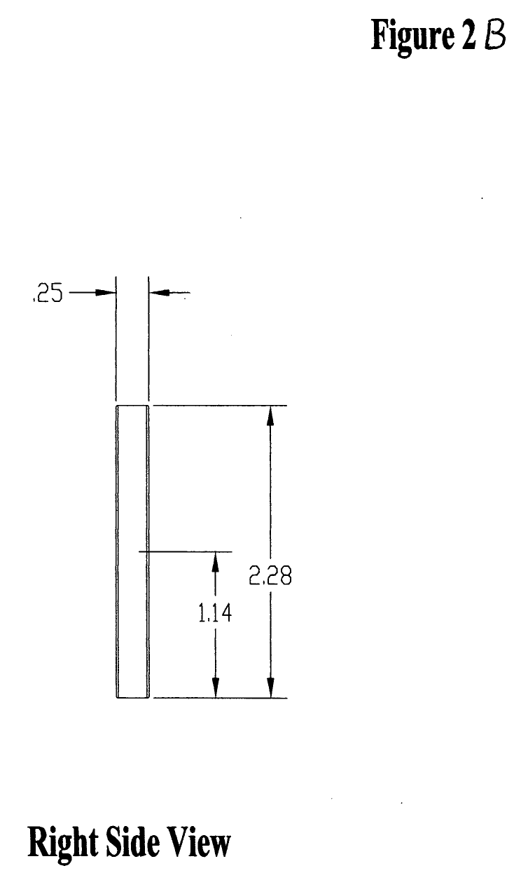

FIG. 2. Side view of oval polycarbonate blank before it is covered with rubber. Both the left and the right views are identical.

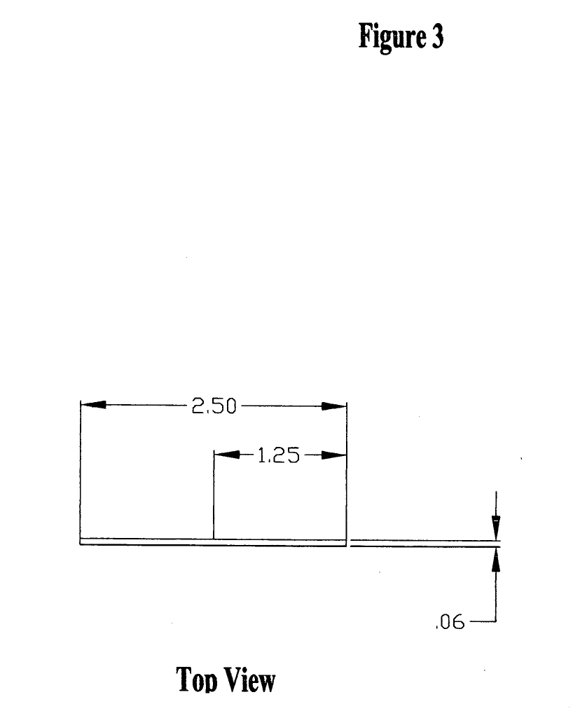

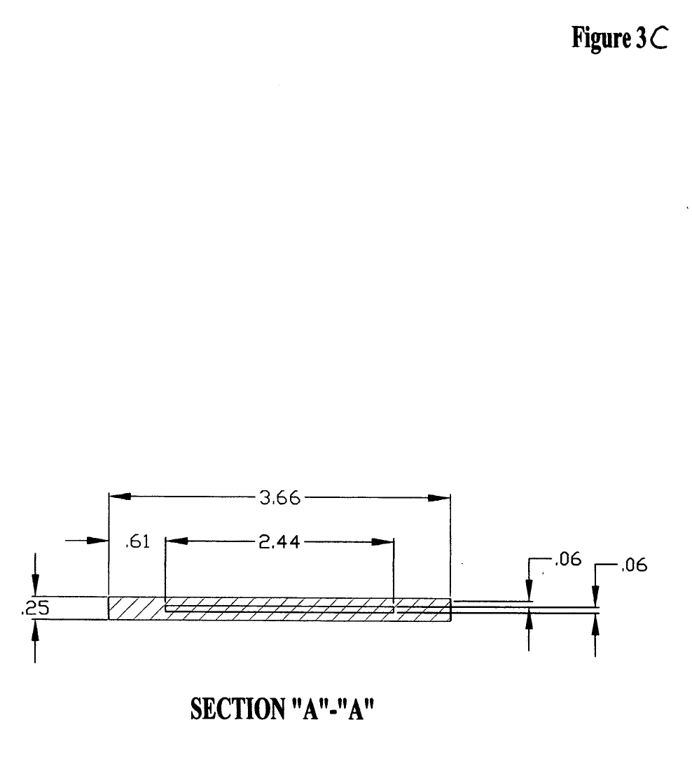

FIG. 3. Top view of the oval polycarbonate blank. Both the top and the bottom view are identical.

FIG. 1A. Front view of oval rubber pad with polycarbonate blank encased in the middle of the rubber.

FIG. 2B. Right Side View of oval rubber pad with polycarbonate blank encased in the middle of the rubber.

3C. Top view of oval rubber pad with polycarbonate blank encased in the middle of the Rubber. The bottom and the top views are identical.

What is claimed is:

1. An apparatus consisting of an oval pad that has high adhering properties because of the suction cup holes and the low Durometer Nexprene 1025 A rubber that is applied to both sides of a polycarbonate flat base plate that will stop or greatly reduce movement in the horizontal direction of anything in the solid state that weighs six ounces or more, that is placed on top of it.

2. Various round and oval pad sizes will be produced to enhance the appearance when placed under all types and size furniture legs that will resist horizontal movement and make up for small variances in vertical pressure to keep the furniture from rocking.

3. The pad installation is as simple as placing them under each leg or item that there is a need to stop or resist horizontal movement.
